(19) United States
(12) Patent Application Publication
(10) Pub. No.: US 2003/0030898 A1
(43) Pub. Date: Feb. 13, 2003

(54) Microscope having switchable illumination in at least two spectral regions, and apparatus for illumination switchover

(75) Inventors: Jasna Roeth, Solms (DE); Manfred Bartel, Solms (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Wetzlar GmbH, Wetzlar (DE)

(21) Appl. No.: 10/213,507

(22) Filed: Aug. 7, 2002

(30) Foreign Application Priority Data
Aug. 8, 2001 (DE) 101 37 964.1

(51) Int. Cl. G02B 1/00; G02B 5/20; F21V 9/06; G02B 21/00; G02B 21/06

(52) U.S. Cl. 359/385; 359/350; 359/361; 359/368

(57) ABSTRACT

A microscope having switchable illumination in at least two spectral regions; having a common illumination beam path, proceeding from at least one light source, preferably a broad-band light source, for the at least two spectral regions; and having a narrow-band wavelength-selective filter (for example, in the IR or UV wavelength region) that can be inserted into the illumination beam path in order to achieve a wavelength-selective illumination in a first of the at least two spectral regions. A broad-band light protection filter, which can be inserted into the illumination beam path alternatively to the wavelength-selective filter, is associated with the illumination beam path. An apparatus for illumination switchover for a microscope of this kind, having switchable illumination in at least two spectral regions, comprises a mechanical positive coupling of the opposite-direction insertion motions of the wavelength-selective filter and/or of the light protection filter.

### CROSS REFERENCE TO RELATED APPLICATIONS

This application claims priority of the German patent application 101 37 964.1 which is incorporated by reference herein.

### FIELD OF THE INVENTION

The invention concerns a microscope having switchable illumination in at least two spectral regions; having a common illumination beam path, proceeding from a broad-band light source, for the at least two spectral regions; and having a narrow-band wavelength-selective filter that can be inserted into the illumination beam path in order to achieve a wavelength-selective illumination in a first of the at least two spectral regions.

### BACKGROUND OF THE INVENTION

Microscopes having switchable illumination for at least two spectral regions are known for a variety of special applications and special examinations with microscopes. Switchover of the microscope to the desired spectral region is accomplished by inserting into the illumination beam path a narrow-band wavelength-selective filter that filters only a specific, narrow wavelength band out of the light of the light source for illumination. After removal of the narrow-band wavelength-selective filter from the illumination beam path, the specimen is irradiated with the entire emitted wavelength region.

For example, so-called UV microscopes, which selectably permit observation and examination of a specimen with UV light, i.e. light of the ultraviolet (=UV) spectral region, or with visible light, are known. Illumination occurs with a broadband light source that emits in both the ultraviolet spectral region and the visible spectral region. The microscope is switched to UV illumination by insertion of a UV-wavelength-selective filter into the illumination beam path. After removal of the UV-wavelength-selective filter from the illumination beam path, the specimen is irradiated with the entire wavelength region emitted by the light source, i.e. with visible and ultraviolet light. All examinations that are usually performed in the visible spectral region are thus possible.

Typical examinations with UV light are, for example, fluorescence examinations, for which the specimens are stained with special UV-reactive fluorescent dyes. When the microscope is switched to UV illumination, specimens stained in this fashion exhibit the desired fluorescent effect. Other microscopic examinations are then performed with visible light (which is superimposed by UV light).

Other examinations in UV light are, for example, the observation and measurement of very small structures, for example on semiconductor substrates. Here the short wavelength of the UV light permits much better resolution, i.e. optical differentiation, of very small structures as compared to examination with visible light. Here again, all examination methods with visible light are available after removal of the UV-wavelength-selective filter from the illumination beam path. Here again, the visible light emerges together with the UV component of the lamp spectrum.

In the context of examinations with UV microscopes with the visible spectral region switched in, the fact that UV light is simultaneously radiated creates the risk, especially if illumination continues for a long period (e.g. due to improper operation or inadvertently during work breaks), of damage to the specimens under examination as a result of that UV light, since its energy is particularly high.

Other microscopes having switchable illumination for at least two spectral regions are the so-called IR microscopes. They selectably permit observation and examination of a specimen with IR light, i.e. light of the infrared (=IR) spectral region, or with visible light. Illumination occurs with a broad-band light source that emits in both the infrared spectral region and the visible spectral region. The microscope is switched to IR illumination by insertion of an IR-wavelength-selective filter into the illumination beam path. After removal of the IR-wavelength-selective filter from the illumination beam path, the specimen is irradiated with the entire emitted wavelength region, i.e. with visible and infrared light. All examinations that are usually performed in the visible spectral region are thus possible.

Typical examinations with IR light are necessary, for example, for electrophysiology. With IR illumination and an IR microscope whose optical components are optimized not only for the visible wavelength region but also for the IR wavelength region, living biological tissue sections up to several hundred micrometers in thickness can easily be examined. For the observations in the infrared wavelength region, the IR-wavelength-selective filter is inserted into the illumination beam path.

Many microscope users, however, do not use the IR microscope only with IR illumination, but also often, and for long periods, use illumination with visible light. For that purpose, the IR-wavelength-selective filter is removed from the illumination beam path. When visible illumination is selected in this fashion, the entire IR wavelength component of the light emitted by the light source is simultaneously also directed through the illumination beam path and onto the specimen. If the microscope is operated in this illumination setting for a long period (e.g. due to improper operation or inadvertently during work breaks), this results in excessive heating of and thus damage to the specimen and to polarizers, which are also arranged in the microscope beam path for specific applications in order to increase contrast in low-contrast living specimens (e.g. with the differential interference contrast method=DIC).

### SUMMARY OF THE INVENTION

It is therefore the object of the present invention to describe a microscope having switchable illumination for at least two spectral regions in which damage to the specimen or to optical components is prevented.

This object is achieved by a microscope having switchable illumination with at least two spectral regions having

a common illumination beam path, proceeding from a broad-band light source, for the at least two spectral regions; and a narrow-band wavelength-selective filter that can be inserted into the illumination beam path in order to achieve a wavelength-selective illumination with a first of the at least two spectral regions,

which, according to the present invention, is characterized in that

a broad-band light protection filter, which can be inserted into the illumination beam path alternatively to the narrow-band wavelength-selective filter, is associated with the illumination beam path.

The wavelength-selective filter for setting the IR or UV illumination is referred to as “narrow-band” because it filters only a narrow wavelength band out of the respectively desired IR region or UV region for the illumination. Narrow-band selection of the illuminating light is necessary because the optical components must be optimized for the desired spectral regions, for example in terms of their transmission, imaging quality, and reflection suppression. This optimization is easier to achieve for a spectrally narrow-band illumination.

The light protection filter is a broad-band filter that can be designed, for example, as either an IR protection filter or a UV protection filter. It is referred to as “broad-band” because it decreases the entire broad-band IR wavelength region emitted by the light source, or the entire broad-band UV wavelength region emitted by the light source, to zero or at least almost to zero.

In present-day microscopes exclusively for the visible spectral region, such protection filters are usually integrated into the lamp housing of the light source. When UV microscopes and IR microscopes were developed, these protection filters were deliberately removed from the lamp housing in order to achieve illumination in the respectively desired spectral region.

A microscope according to the present invention can have, for example, switchable illumination in the ultraviolet spectral region or in the visible spectral region. In this context, the narrow-band wavelength-selective filter is embodied as an ultraviolet-wavelength-selective UV filter that can be inserted into the illumination beam path in order to achieve an ultraviolet-wavelength-selective illumination. For a microscope of this kind, the light protection filter is embodied as a broad-band ultraviolet protection filter that can be inserted into the illumination beam path alternatively to the ultraviolet-wavelength-selective UV filter.

Another microscope according to the present invention can have, for example, switchable illumination in the infrared spectral region or in the visible spectral region. In this context, the narrow-band wavelength-selective filter is embodied as an infrared-wavelength-selective IR filter that can be inserted into the illumination beam path in order to achieve an infrared-wavelength-selective illumination. For a microscope of this kind, the light protection filter is embodied as a thermal protection filter that can be inserted into the illumination beam path alternatively to the infrared-wavelength-selective IR filter.

The aforesaid microscopes can be embodied both as upright or as inverted microscopes. Depending on the embodiment, the microscope stage can be embodied in fixed fashion (a “fixed-stage” microscope) or as an X-Y stage, possibly also with vertical adjustment.

It is possible to perform introduction and removal of the wavelength-selective filter and/or of the light protection filter manually. The microscope can, however, also comprise a motorized operating capability for introducing and then removing the wavelength-selective filter and/or the light protection filter. It has proven to be particularly advantageous if the operating capability (both manual and motorized) encompasses a positive coupling for the opposite-direction insertion motions of the wavelength-selective filter and/or of the light protection filter.

This positive coupling can be embodied mechanically. With manual operation, it then proves to be advantageous if the operating elements are arranged within the user's ergonomic reach. For that purpose, the wavelength-selective filter and the light protection filter can be arranged in the stand foot of the microscope, and the associated operating elements can be mounted in externally accessible fashion on the microscope.

Introduction and removal of the wavelength-selective filter and of the associated protection filter by means of a positive coupling can also be accomplished in motorized fashion. Activation of the positively coupled spectral region switchover can then be accomplished by way of a computer and in program-controlled fashion.

A further object of the invention is to describe an apparatus for illumination switchover of a microscope for at least two spectral regions which excludes the possibility of incorrect operation when setting the illumination of the microscope.

This object is achieved by an apparatus for illumination switchover of a microscope, having switchable illumination in at least two spectral regions, that comprises, in a common illumination beam path for the at least two spectral regions proceeding from a broad-band light source, a narrow-band wavelength-selective filter that can be inserted into the illumination beam path in order to achieve a wavelength-selective illumination in a first of the at least two spectral regions, which according to the present invention is characterized in that

the apparatus for wavelength switchover comprises means for reversible insertion of the narrow-band wavelength-selective filter into the illumination beam path;

the apparatus for wavelength switchover comprises means for reversible insertion into the illumination beam path of an additional broad-band light protection filter which can be introduced into the illumination beam path alternatively to the wavelength-selective filter; and

the apparatus for wavelength switchover encompasses a positive coupling of the opposite-direction insertion motions of the wavelength-selective filter and/or of the light protection filter.

The apparatus according to the present invention for illumination switchover of a microscope offers a high degree of user safety with the mechanical positive coupling of the opposite-direction motions (for insertion and removal) of the wavelength-selective filter and/or of the light protection filter, since incorrect operation of a microscope upon illumination switchover is ruled out. Actuation of the positive coupling can be accomplished either mechanically or in motorized fashion.

### BRIEF DESCRIPTION OF THE DRAWINGS

The invention is explained in more detail below with reference to the schematic drawings, in which:

FIG. 1 shows an upright microscope having switchable illumination in two spectral regions;

FIG. 2 shows an inverted microscope having switchable illumination in two spectral regions;

FIG. 3 shows an apparatus for illumination switchover in the “IR illumination on” switching state;

FIG. 4 shows an apparatus for illumination switchover in the “IR illumination off” switching state.

### DETAILED DESCRIPTION OF THE INVENTION

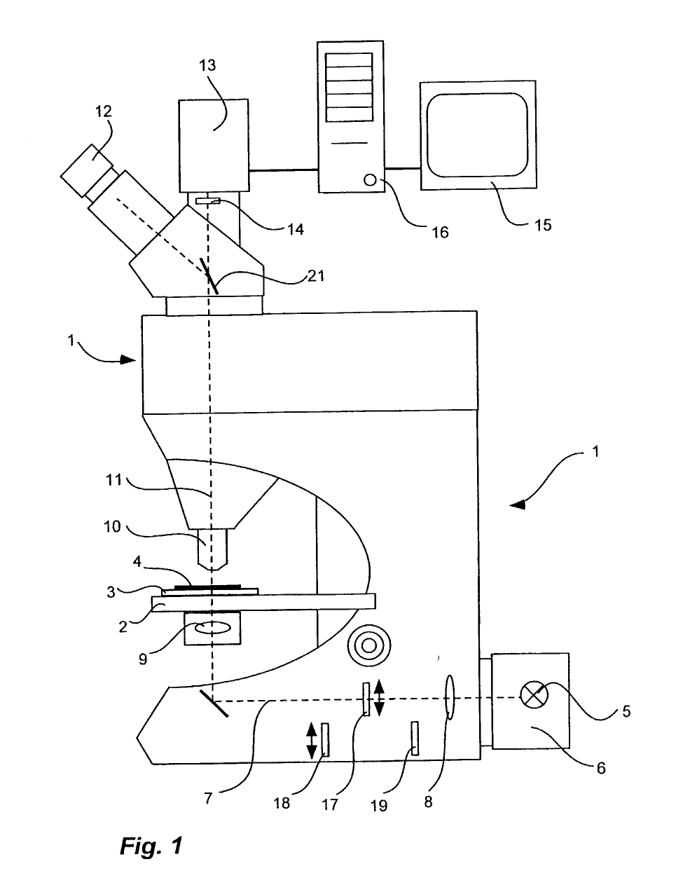

An upright microscope 1 with switchable illumination in at least two spectral regions is depicted in FIG. 1. In this embodiment, the two switchable spectral regions are an infrared spectral region (abbr.: “IR region”) and the visible spectral region (abbr.: “VIS region”).

In the embodiment depicted here, microscope 1 has a fixed microscope stage 2. Microscope stage 2 serves to receive a specimen holder 3 on which is mounted a specimen 4 that is to be viewed or examined. Specimen holder 3 can be, for example, a glass specimen slide or a Petri dish.

Microscope 1 that is depicted is a transmitted-light microscope, in which an illumination device is arranged beneath microscope stage 2 and specimen 4. The illumination system comprises a light source 5 in a lamp housing 6, from which proceeds an illumination beam path having an optical axis 7. Light source 5 emits both in the visible spectral region and in the infrared spectral region. The illumination beam path is directed from below, through an illumination optical system 8 and a condenser 9, onto specimen holder 3 with specimen 4 arranged on microscope stage 2.

Light passing through specimen 4 travels to an objective 10 of microscope 1 that is arranged above microscope stage 2 and specimen 4. Objective 10 defines an optical axis 11 that is aligned with optical axis 7 of the illumination system. Microscope 1 can comprise multiple objectives 10 as well as an objective changing apparatus, which are not depicted here for simplicity's sake. Since a fixed microscope stage 2 is used in the embodiment shown here, focusing of the illuminating light onto specimen 4 is accomplished by vertical adjustment of objective 10. Within microscope 1, the light is directed via lenses and mirrors (not depicted) to at least one eyepiece 12 of microscope 1, through which an operator can view specimen 4 arranged on microscope stage 2.

Microscope 1 is furthermore equipped with an IR-sensitive camera 13 that acquires an image of specimen 4 under IR illumination. For that purpose, the imaging beam path is spectrally split at a beam splitter 14 into one beam path for the visible spectral component (abbr.: “VIS component”) and one beam path for the purely infrared spectral component (abbr.: “IR component”). The purely IR component of the imaging beam path is directed to IR camera 13. In addition, a camera also can be provided for the VIS light (not depicted here). The light of the particular illumination that is set travels via an optical element 21 to the at least one eyepiece 12, i.e., in the embodiment shown here, with each type of illumination.

The image acquired by camera 13 is displayed on a monitor 15 that is connected to a computer 16. The system made up of computer 16, camera 13, and monitor 15 can be used to control motorized microscope functions such as, for example, filter adjustment apparatuses or an autofocus device (not depicted) for microscope 1.

In order to be able to perform the illumination switchover between the two spectral regions, a narrow-band IR-selective filter 17 is associated with the illumination beam path. Switchover of microscope 1 to the desired spectral region is accomplished by inserting said IR-selective filter 17, which filters only a specific, narrow IR wavelength band out of the light of the light source for illumination, into the illumination beam path. After the removal of IR-selective filter 17 from the illumination beam path, the sample would be irradiated with the entire wavelength region emitted by the light source, i.e. with the VIS/IR region.

According to the present invention, the illumination beam path therefore additionally has associated with it a broad-band IR protection filter 18 (also referred to as a “thermal protection filter”) that can be inserted into the illumination beam path alternatively to IR-selective filter 17. The IR protection filter decreases the entire broad-band IR spectral component emitted by the light source considerably, or entirely to zero. When IR-selective filter 17 is removed from the illumination beam path and broad-band IR protection filter 18 is alternatively inserted into the illumination beam path, for the most part only visible light (i.e. only the VIS components of the lamp spectrum) enters the illumination beam path. Damage to specimen 4 or to the optical components due to IR irradiation can thereby be reliably and dependably prevented.

In addition, the insertion and removal of IR-selective filter 17 and IR protection filter 18 can be accomplished in motorized fashion. Control of the spectral region switchover can then be accomplished using computer 16. In this context, IR protection filter 18 can be removed in program-controlled fashion from the illumination beam path when IR-selective filter 17 is inserted into the illumination beam path, and vice versa. This coupled opposite-direction motion offers the greatest possible protection for specimen 4 and the optical components.

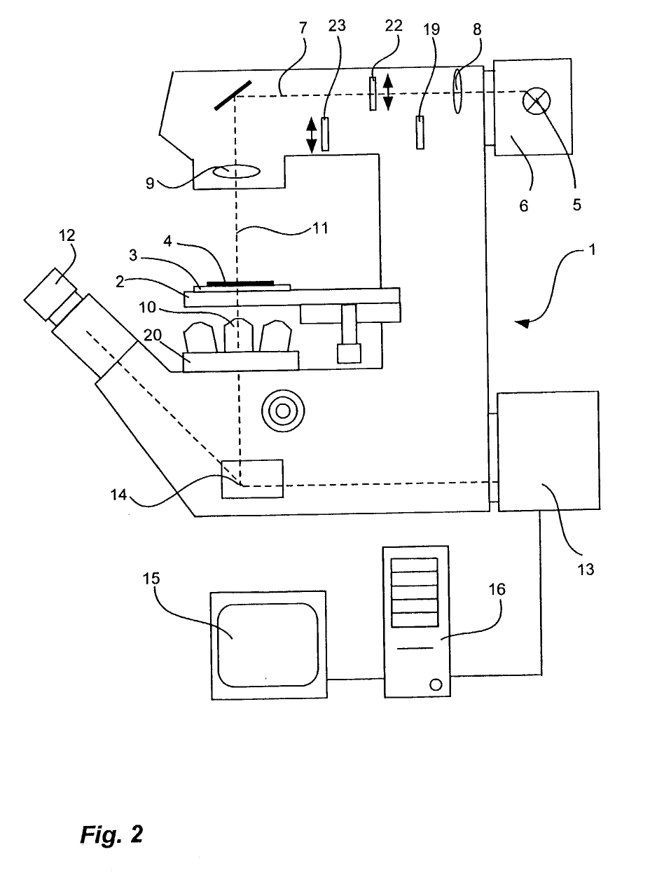

An inverted microscope 1 with switchable illumination in at least two spectral regions is depicted in FIG. 2. In this embodiment, the two switchable spectral regions are an ultraviolet spectral region (abbr.: “UV region”) and the visible spectral region (abbr.: “VIS region”).

In the embodiment depicted here, microscope 1 has a displaceable microscope stage 2. Microscope stage 2 serves to receive a specimen holder 3 on which is mounted a specimen 4 that is to be viewed or examined. Specimen holder 3 can be, for example, a glass specimen slide or a Petri dish.

Microscope 1 that is depicted is a transmitted-light microscope, in which an illumination device is arranged above microscope stage 2 and specimen 4. The illumination system comprises a light source 5 in a lamp housing 6, from which proceeds an illumination beam path having an optical axis 7. Light source 5 emits both in the visible spectral region and in the ultraviolet spectral region. The illumination beam path is directed from above, through an illumination optical system 8 and a condenser 9, onto specimen holder 3 with specimen 4 arranged on microscope stage 2.

Light passing through specimen 4 travels to an objective 10 of microscope 1 that is arranged below microscope stage 2 and specimen 4. Objective 10 defines an optical axis 11 that is aligned with optical axis 7 of the illumination system. Microscope 1 can comprise multiple objectives 10 as well as an objective changing apparatus 20. Focusing of the illuminating light onto specimen 4 is accomplished by vertical adjustment of objective 10. Within microscope 1, the light is directed via lenses and mirrors (not depicted) to at least one eyepiece 12 of microscope 1, through which an operator can view specimen 4 arranged on microscope stage 2.

Microscope 1 is furthermore equipped with a UV-sensitive camera 13 that acquires an image of specimen 4 under UV illumination. For that purpose, the imaging beam path is spectrally split at a beam splitter 14 into one beam path for the ultraviolet spectral component (abbr.: “UV component”) and one beam path for the purely visible spectral component (abbr.: “VIS component”). The UV component of the imaging beam path is directed to camera 13, and the purely VIS component of the illumination beam path to the at least one eyepiece 12. The eye of an operator of microscope 1 is thereby protected from damaging UV radiation.

The image acquired by camera 13 is displayed on a monitor 15 that is connected to a computer 16. The system made up of computer 16, camera 13, and monitor 15 can be used to control motorized microscope functions such as, for example, filter adjustment apparatuses or an autofocus device (not depicted) for microscope 1.

In order to be able to perform the illumination switchover between the two spectral regions, a narrow-band UV-selective filter 22 is associated with the illumination beam path. Switchover of microscope 1 to the desired spectral region is accomplished by inserting said UV-selective filter 22, which filters only a specific, narrow UV wavelength band out of the light of the light source for illumination, into the illumination beam path. After the removal of UV-selective filter 22 from the illumination beam path, the sample would be irradiated with the entire wavelength region emitted by the light source, i.e. with the VIS/UV region.

According to the present invention, the illumination beam path additionally has associated with it a broad-band UV protection filter 23 that can be inserted into the illumination beam path alternatively to narrow-band UV-selective filter 22. The UV protection filter decreases the entire broad-band UV spectral component emitted by the light source considerably, or entirely to zero. When UV-selective filter 22 is removed from the illumination beam path and broad-band UV protection filter 23 is alternatively inserted into the illumination beam path, only visible light (i.e. only the VIS components of the lamp spectrum) enters the illumination beam path. Damage to specimen 4 or to optical components due to UV irradiation can thereby be prevented.

In addition, the insertion and removal of UV-selective filter 22 and UV protection filter 23 can be accomplished in motorized fashion. Control of the spectral region switchover can then be accomplished using computer 16. In this context, UV protection filter 23 can be removed in program-controlled fashion from the illumination beam path when UV-selective filter 22 is inserted into the illumination beam path, and vice versa. This coupled opposite-direction motion offers the greatest possible protection for specimen 4 and the optical components.

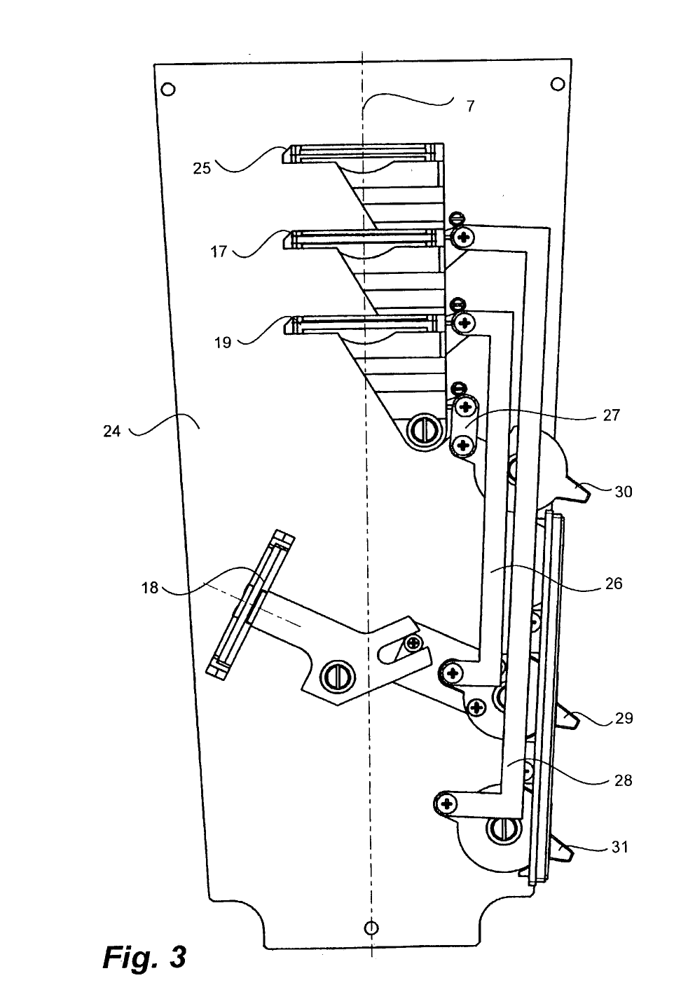

FIG. 3 shows an apparatus for illumination switchover, which comprises a mechanical positive coupling of the opposite-direction insertion motions of the wavelength-selective filter and/or the light protection filter, in the “IR illumination on” switching state.

The Figure depicts an apparatus for illumination switchover in a stand foot 24 of a microscope (not depicted) having switchable illumination in at least two spectral regions. The light source (not depicted here) of the microscope is located at the wide end of stand foot 24. In the example shown here, the switchover occurs between a narrow-band IR wavelength region and the visible (VIS) wavelength region. Very similarly, this apparatus can be used for switchover between a narrow-band UV wavelength region and the visible (VIS) wavelength region, by adapting the corresponding filters and protection filters for the UV region.

A common illumination beam path having one optical axis 7 for the two spectral regions (IR and VIS) proceeds from a broad-band IR/VIS light source. The “IR illumination on” switched position is depicted.

A narrow-band IR-wavelength-selective filter 17, which generates an IR illumination, is therefore inserted into the illumination beam path. Additionally arranged outside the illumination beam path is a broad-band IR protection filter 18 which can be inserted into the illumination beam path alternatively to the wavelength-selective filter.

According to the present invention, the apparatus for illumination switchover comprises a positive coupling for the opposite-direction insertion motions of IR-wavelength-selective filter 17 and broad-band IR protection filter 18. For that purpose, IR-wavelength-selective filter 17 and broad-band IR protection filter 18 are mechanically connected via a positive coupling positioning lever 26. Operation of the illumination switchover is accomplished via an operating element 29 for the positive coupling. This operating element 29 is embodied as a rocker arm. Movement of this rocker arm would, by means of positive coupling positioning lever 26, remove IR-wavelength-selective filter 17 out of the illumination beam path and insert broad-band IR protection filter 18 in the opposite direction into the illumination beam path.

It is also conceivable to accomplish actuation of the positive coupling in motorized fashion. For that purpose, it would be necessary to provide, instead of operating element 29 for the positive coupling, a motorized drive system that can then be actuated by way of an electrical switch, pushbutton, etc., or by way of a computer.

The Figure depicts two further optical elements that, in the present example, are associated with the illumination beam path of the microscope. One is a light stop 25 that, by way of a separate light stop control element 31 and by means of a light stop positioning lever 28, can be inserted into the illumination beam path (as depicted) or removed from it. Light stop 25 is located as close as possible to the light source (not depicted), i.e. at the wide end of stand 24, so that when necessary, complete shutoff (i.e. complete darkening) of the illumination beam path can be effected with the smallest possible diameter. Insertion of light stop 25 can be performed independently of the type of illumination that is set.

Also depicted is a diffusion disk 19 that, by way of a separate diffusion disk operating element 30 and by means of a diffusion disk positioning lever 27, can be inserted into the illumination beam path (as depicted) or removed from it. Diffusion disk 19 is inserted in order to produce a homogeneous light.

With the mechanical positive coupling of the opposite-direction motions (upon insertion and then removal) of the wavelength-selective IR filter and the IR protection filter, the apparatus according to the present invention for illumination switchover of a microscope offers a high degree of user protection, since improper operation of the microscope upon illumination switchover is ruled out.

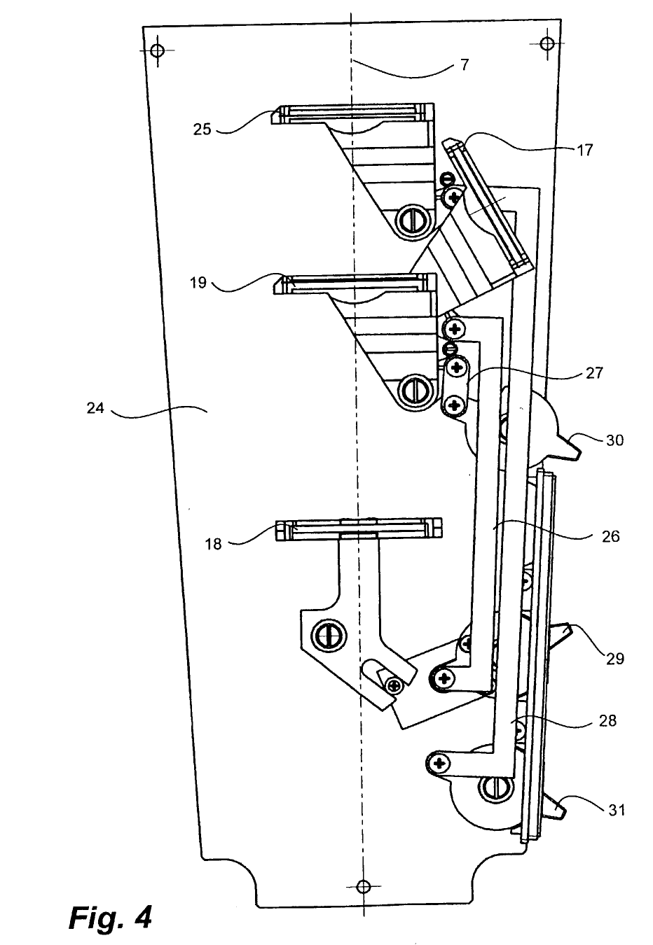

FIG. 4 shows the apparatus of FIG. 3 in the “IR illumination off” or “VIS illumination on” switching state. Identical components are labeled with the same reference characters as in FIG. 3.

The Figure shows that after movement of operating element 29 for the positive coupling (rocker arm), IR-wavelength-selective filter 17 has been removed from the illumination beam path by means of positive coupling positioning lever 26. At the same time, broad-band IR protection filter 18 has been inserted in the opposite direction into the illumination beam path. Pure VIS illumination is thereby implemented, i.e. downstream from the IR protection filter only visible light is present in the illumination beam path. Any damage to specimens or to optical components due to IR irradiation is thus reliably ruled out. Convenient and safe illumination switchover is therefore achieved.

The switched positions of light stop 25 and of diffusion disk 19 are unchanged as compared to FIG. 3.

### Parts List

1 Microscope

2 Microscope stage

3 Specimen holder

4 Specimen

5 Light source

6 Lamp housing

7 Optical axis of illumination beam path

8 Illuminating optical system

9 Condenser

10 Objective

11 Optical axis of imaging beam path

12 Eyepiece

13 Camera

14 Beam splitter

15 Monitor

16 Computer

17 IR-selective filter

18 IR protection filter

19 Diffusion disk

20 Objective changing apparatus

21 Optical element

22 UV-selective filter

23 UV protection filter

24 Stand foot of a microscope

25 Light stop

26 Positive coupling positioning lever

27 Diffusion disk positioning lever

28 Light stop positioning lever

29 Operating element for positive coupling

30 Diffusion disk operating element

31 Light stop operating element

What is claimed is:

1. A microscope comprising:
means for a switchable illumination in at least two spectral regions;
a broad-band light source;
a common illumination beam path for said at least two spectral regions, said illumination path proceeding from said broad-band light source;
a narrow-band wavelength-selective filter that can reversibly be inserted into the illumination beam path in order to achieve a wavelength-selective illumination in a first of said at least two spectral regions,
and a broad-band light protection filter, which can reversibly be inserted into the illumination beam path alternatively to said wavelength-selective filter.

2. The microscope as defined in claim 1, wherein the microscope is embodied as an upright or an inverted microscope.

3. The microscope as defined in claim 1, wherein the microscope is embodied as an upright or an inverted microscope, and the microscope stage is embodied in fixed fashion.

4. The microscope as defined in claim 2, comprising:
means for a switchable illumination in the ultraviolet spectral region or alternatively in the ultraviolet to visible spectral region;
a wavelength-selective filter which is embodied as an ultraviolet-wavelength-selective UV filter that can be inserted into the illumination beam path in order to achieve an ultraviolet-wavelength-selective illumination; and
a light protection filter which is embodied as an ultraviolet protection filter that can be inserted into the illumination beam path alternatively to the ultraviolet-wavelength-selective UV filter.

5. The microscope as defined in claim 3, comprising:
means for a switchable illumination in the ultraviolet spectral region or alternatively in the ultraviolet to visible spectral region;
a wavelength-selective filter which is embodied as an ultraviolet-wavelength-selective UV filter that can be inserted into the illumination beam path in order to achieve an ultraviolet-wavelength-selective illumination; and
a light protection filter which is embodied as an ultraviolet protection filter that can be inserted into the illumination beam path alternatively to the ultraviolet-wavelength-selective UV filter.

6. The microscope as defined in claim 2, comprising:
means for a switchable illumination in the infrared spectral region or in the infrared to visible spectral region;
a wavelength-selective filter which is embodied as an infrared-wavelength-selective IR filter that can be inserted into the illumination beam path in order to achieve an infrared-wavelength-selective illumination; and
a light protection filter which is embodied as a thermal protection filter that can be inserted into the illumination beam path alternatively to the infrared-wavelength-selective IR filter.

7. The microscope as defined in claim 3, comprising:
means for a switchable illumination in the infrared spectral region or in the infrared to visible spectral region;
a wavelength-selective filter which is embodied as an infrared-wavelength-selective IR filter that can be inserted into the illumination beam path in order to achieve an infrared-wavelength-selective illumination; and
a light protection filter which is embodied as a thermal protection filter that can be inserted into the illumination beam path alternatively to the infrared-wavelength-selective IR filter.

8. The microscope as defined in claim 1, comprising manual operating means for manually introducing and then removing the wavelength-selective filter and/or the light protection filter.

9. The microscope as defined in claim 1, comprising a motor drive for motorized introducing and then removing the wavelength-selective filter and/or the light protection filter.

10. The microscope as defined in claim 8, comprising a positive coupling for the opposite-direction insertion motions of the wavelength-selective filter and/or of the light protection filter.

11. The microscope as defined in claim 9, comprising a positive coupling for the opposite-direction insertion motions of the wavelength-selective filter and/or of the light protection filter.

12. The microscope as defined in claim 10, wherein the positive coupling is embodied mechanically, and the wavelength-selective filter and the light protection filter are arranged in the stand foot of the microscope.

13. The microscope as defined in claim 11, wherein the positive coupling is embodied mechanically, and the wavelength-selective filter and the light protection filter are arranged in the stand foot of the microscope.

14. An apparatus for illumination switchover for a microscope, said microscope having at least one light source emitting light of at least two spectral regions and a common illumination beam path for said at least two spectral regions proceeding from said light source, said apparatus comprising:
a narrow-band wavelength-selective filter which can be inserted into the illumination beam path in order to achieve a wavelength-selective illumination in a first of said at least two spectral regions,
means for reversible insertion of said narrow-band wavelength-selective filter into the illumination beam path;
a broad-band light protection filter which can be inserted into the illumination beam path alternatively to the wavelength-selective filter
means for reversible insertion of said broad-band light protection filter into the illumination beam path whereby said broad-band light protection filter inserted alternatively to the wavelength-selective filter.

15. An apparatus for illumination switchover for a microscope as defined in claim 14, comprising a mechanical positive coupling of the opposite-direction insertion motions of the wavelength-selective filter and/or of the light protection filter.
